(19) United States
(12) Patent Application Publication
(10) Pub. No.: US 2026/0288763 A1
(43) Pub. Date: Sep. 24, 2026

(54) COMPUTERIZED SYSTEMS AND METHODS FOR MULTI-MODAL LARGE LANGUAGE MODEL BASED CLUSTERING

(71) Applicant: Bytedance Technology Ltd., Grand Cayman (KY)

(72) Inventors: Yiqun Duan, Sydney (AU); Ziye Chen, Sydney (AU); Riheng Zhu, Sydney (AU); Zhenbang Sun, Sydney (AU)

(21) Appl. No.: 19/575,841

(22) Filed: Mar. 23, 2026

Related U.S. Application Data
(60) Provisional application No. 63/776,652, filed on Mar. 24, 2025.

(51) Int. Cl. G06F 16/28

(52) U.S. Cl. CPC G06F 16/285

(57) ABSTRACT

A computing system is provided is provided that includes processing circuitry configured to, for each of a plurality of input images, input to a multi-modal large language model (MLLM) a corresponding input image with embedding-generation instruction text describing user-interests, and via the MLLM, generate a response to the embedding-generation instruction text. The processing circuitry is further configured to construct a weighted relational graph including a plurality of nodes connected by edges, each node corresponding to one of the plurality of input images and each edge being assigned by a trained adapter layer a weight determined by pairwise similarity between the user-interest-biased embeddings corresponding to the respective nodes each edge connects. The processing circuitry is further configured to perform clustering of the nodes in the weighted relational graph using an MLLM-based agent, to identify a plurality of clusters based on the user-interests, and output the plurality of clusters.

### CROSS REFERENCE TO RELATED APPLICATIONS

This application claims priority to U.S. provisional application No. 63/776,652, filed Mar. 24, 2025, the entirety of which is hereby incorporated herein by reference for all purposes.

### BACKGROUND

Clustering is a fundamental technique in unsupervised learning that partitions data into meaningful groups, uncovering underlying structures within a dataset. Traditional clustering relies on handcrafted features or fixed representations, which may fail to capture the inherent complex data relationships. Recent advances leverage learning-based techniques to obtain more expressive representations, leading to significant performance improvements. Most of these approaches produce only one data partition from a single perspective.

### SUMMARY

According to one aspect of the present disclosure a computing system is provided, comprising processing circuitry and associated memory storing instructions, the processing circuitry executing the instructions causes the processing circuitry to: for each of a plurality of input images, input to a multi-modal large language model (MLLM) a corresponding input image together with embedding-generation instruction text describing one or more user-interests, and via the MLLM, generate a response to the embedding-generation instruction text. The processing circuitry is further configured to construct a weighted relational graph including a plurality of nodes connected by edges, in which each node corresponds to one of the plurality of input images and each edge is each assigned by a trained adapter layer a weight determined by pairwise similarity between the user-interest-biased embeddings corresponding to the respective nodes each edge connects. The processing circuitry is further configured to perform clustering of the nodes in the weighted relational graph using an MLLM-based agent, to identify a plurality of clusters based on the user-interests; and output the plurality of clusters.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically represents a computing system with processing circuitry configured to execute a multimodal large language model (MLLM) for carrying out embedding extraction, relational-graph formation, and MLLM-agent-based, user-interest-tailored clustering, according to one example embodiment.

FIG. 2 is a schematic representation of embedding-extraction and relational-graph formation processes carried out by the computing system of FIG. 1.

FIG. 3 illustrates a workflow of an agent-centric multiple clustering framework implemented by the computing system of FIG. 1.

FIG. 4 illustrates the agent-centric graph traversal process for cluster searching, as implemented by the computing system of FIG. 1.

FIG. 5 illustrates image embedding extraction using MLLM based on user interests described in a prompt, as implemented by the computing system of FIG. 1.

FIG. 6 illustrates how an MLLM agent assesses whether a candidate node qualifies for membership in a current cluster according to binary pseudo label based on user interests, as implemented by the computing system of FIG. 1.

FIG. 7 at (A) plots relationships between graph density and clustering performance, at (B) traversal steps and clustering performance, and at (C) graph density and traversal steps, for the computing system of FIG. 1.

FIG. 8 shows visualization of MLLM-based and CLIP-based embeddings with corresponding labels on the Fruit dataset, where for color-based embeddings, red, green, and yellow points correspond to fruits that are red, green, and yellow, respectively, and for species-based embeddings, red, yellow, and purple points correspond to apples, bananas, and grapes, respectively.

FIG. 9 shows an Algorithm 1 implemented by the computing system of FIG. 1.

FIG. 10 shows Table 1, which compares state-of-the-art methods across multiple clustering benchmarks, where for methods using k-means for clustering, the algorithm is run 10 times to account for its inherent randomness, with the average clustering performance reported, and all methods are evaluated using two metrics: Normalized Mutual Information (NMI) and Rand Index (RI).

FIG. 11 shows Table 2, which presents an ablation study on the Fruit360, Card, and CMUface datasets, demonstrating that agent-centric graph traversal clearly outperforms K-Means and HDBSCAN on both kinds of embeddings, while MLLM embeddings show significant advantages over CLIP embedding in reducing the traversal steps.

FIG. 12 shows Table 3, which presents an ablation study on number of representative nodes K.

FIG. 13 shows a schematic view of an example computing environment in which the computing system of FIG. 1, 2, 3, 4 or 5 may be enacted.

FIG. 14 is a computerized method for MLLM-based clustering according to one embodiment of the present disclosure.

### DETAILED DESCRIPTION

Personalized multiple clustering aims to generate diverse partitions of a dataset based on different user-specific aspects, rather than a single clustering. It has recently drawn research interest for accommodating varying user preferences. Recent approaches primarily use CLIP embeddings with proxy learning to extract representations biased toward user clustering preferences. However, CLIP primarily focuses on coarse image-text alignment, lacking a deep contextual understanding of user interests. To overcome these limitations, an agent-centric personalized clustering framework is proposed herein, leveraging multi-modal large language models (MLLMs) as agents to comprehensively traverse a relational graph to search for clusters based on user interests. Due to the advanced reasoning mechanism of MLLMs, the obtained clusters align more closely with user-defined criteria than those obtained from CLIP-based representations. To reduce computational overhead, the agents' traversal path is shortened by constructing a relational graph using user-interest-biased embeddings extracted by MLLMs. A large number of weakly connected edges can be filtered out based on embedding similarity, facilitating an efficient traversal search for agents. Experimental results show that the proposed method achieves NMI scores of 0.9667 and 0.9481 on the Card Order and Card Suits benchmarks, respectively, largely improving the SOTA model by over 140%, as further discussed below.

Real-world data exhibit inherent complexity, making it impossible for any single clustering technique to capture all relevant structures. Consequently, identifying multiple valid clusterings within a dataset is important to address various analytical needs. This sort of need for user-tailored grouping capabilities has driven the development of personalized multiple clustering, which aims to generate diverse partitions of a dataset based on different user preferences, rather than a single fixed solution.

Typical multiple clustering methods primarily leverage autoencoders and data augmentation to extract diverse data representations, enabling clustering from different perspectives. However, identifying which clustering outcome aligns with user interests remains challenging, as these interests are often expressed through abstract keywords. Recent approaches integrate CLIP embeddings with proxy learning to obtain data representations tailored to user clustering preferences. While effective, CLIP is trained on coarse-grained image-text pair datasets and primarily focuses on direct modality alignment, lacking the deep contextual understanding necessary to capture abstract and complex user preferences. Furthermore, CLIP embeddings are derived from a fixed encoding of input images and predefined prompts, lacking the dynamic contextual reasoning needed to adapt to diverse and nuanced user interests.

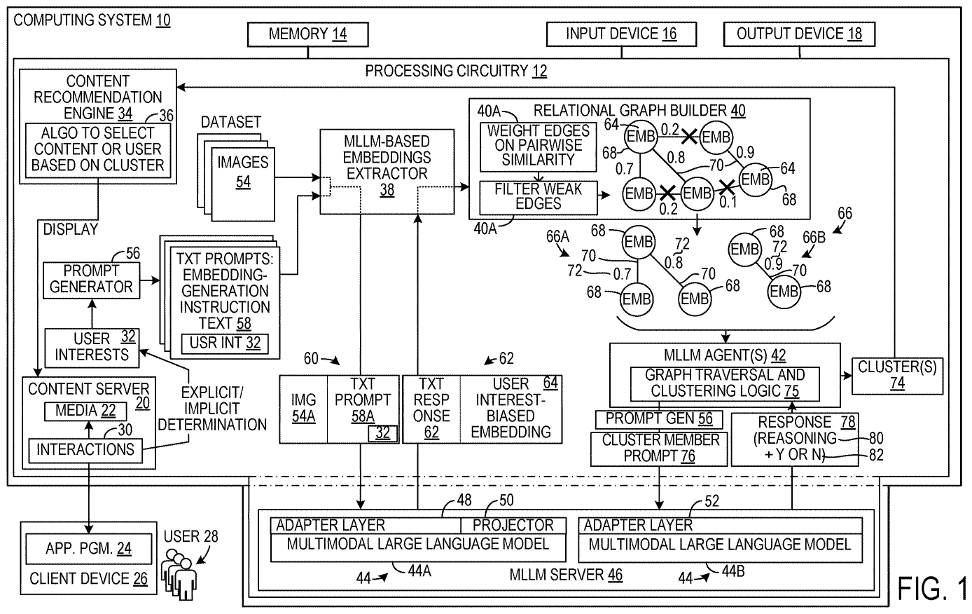

To address these limitations, a computing system 10 is provided as schematically represented in FIG. 1. Computing system 10 includes processing circuitry 12 and associated memory 14 storing instructions (i.e., software) that, when executed by the processing circuitry 12, cause the processing circuitry 12 to implement the various functions described herein. Input devices 16 such as keyboards, pointing devices, and touch screens, as well as output devices 18 such as displays, speakers, etc. are communicatively coupled to the processing circuitry 12. The computing system 12 may include one or more networked computing devices, and thus it will be appreciated that processing circuitry 12, memory 14, input devices 16, and output devices 18 can be distributed across a plurality of computing devices.

In the depicted implementation, computing system 10 includes a content server 20 configured to serve content such as media 22 to instances of client application programs 24 executed on client devices 26. The content server 20 may be configured as a social media platform and the client application program can be configured as a social media application. The content server 20 can be configured to receive the media 22 in posts as user generated content from users 28 as well as sponsored content from sponsors. The content server 20 may be configured to display the received media 22 in a media content feed via client application program 24. Users 26 can perform a variety of interactions 30 with the media 22 appearing in the media content feed, such as liking, commenting on, and sharing the media, etc.

In order to select appropriate content to display to each user in the user's media content feed via the content server 20, the content server is configured to infer user interests 32 from interactions 30 with media 22 on the content server 20, both through explicit and implicit expressions of user interest 32. For example, a user's likes, shares, and comments regarding a particular item of media 22 can be used to make determinations of inferred user interest 32 in the features (e.g., topic, quality, characteristics) of the media 22. These user interests 32 can be represented in various forms, such as a list or set of semantic expressions corresponding to each user interest 32. These can be based on an interaction history window that covers a predetermined period of time or number of interactions, for example. In this way, the content server can maintain a current representation of the user interests 32 of each user. For simplicity, the users can be clustered by interest type, so that a set of users is identified who are interested in particular media features. Further, related media 22 can be clustered by features so that media 22 related to a particular topic, or featuring a particular type of content can be grouped together. In this way, when determining which media to present to which users in a media content feed, the clusters can be compared to each other, reducing the complexity and processing time required for the matching algorithm to execute. In this manner, clustering enables a content recommendation engine 34 to implement an algorithm 36 to select content (media) to be displayed or a user to display content to, by searching over clusters of media and clusters of users, rather than searching over each individual user and individual media item, saving processing time.

To address the drawbacks associated with prior personalized multiple clustering algorithms computing system 10 is provided with improved clustering capabilities, as follows. Broadly, the clustering operations are carried out in a pipeline of operations performed by an MLLM-based embeddings extractor 38, a relational graph builder 40, and one or more MLLM agents 42. The MLLM-based embeddings extractor 38 and MLLM agents 42 are configured to communicate with respective instances 44A, 44B of an MLLM 44 executed on an MLLM server 46. A first instance of the MLLM 44A includes a first adapter layer 48, such as a Low Rank Adapter (LoRA), and a projector 50. A second instance of the MLLM includes a second adapter layer 52, which also may be a Low Rank Adapter (LoRA). It will be appreciated that adapter layers 48 and 52 are distinct and trained separately. Performing clustering of input images according to user interests at inference time will be explained, with references to training where appropriate.

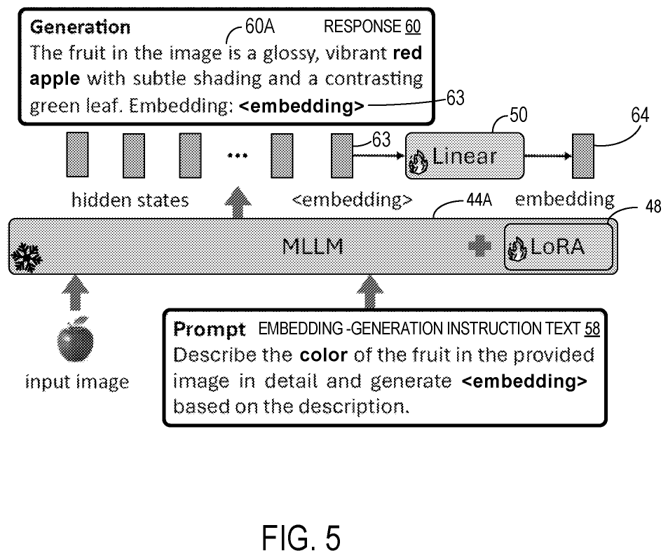

It will be appreciated that each user 28 of the content server 20 has different, i.e., personalized, user interests 32, which are stored in a manner associated with a user account of the user 28 on the content server. It is an object of the clustering pipeline of the subject disclosure to enable clustering of images 54 based on user interests 32 for each particular user. To accomplish this, a prompt generator 56 is configured to generate embedding-generation instruction text 58 that includes an instruction to the MLLM to describe certain features of the images 54 and includes a description of one or more the user-interests 32. Example embedding-generation instruction text 58 is illustrated in FIG. 5.

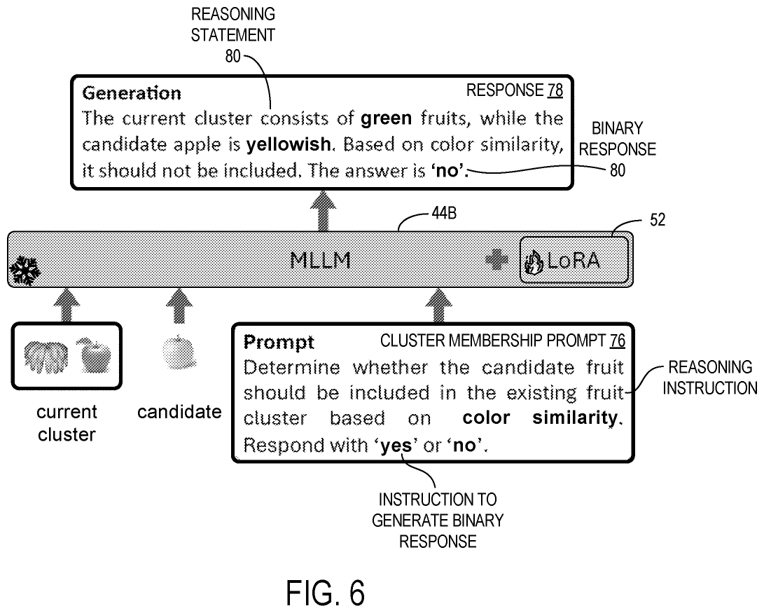

Next, for each of a plurality of input images 54, the processing circuitry 12 is configured to input to the multi-modal large language model (MLLM) 44A an input 60 including a corresponding input image 54A from a dataset 53 together with embedding-generation instruction text 58A describing one or more the user-interests 32. The processing circuitry 12 is further configured to, via the MLLM 44A, generate a response 60 to the embedding-generation instruction text. The response 60 includes a text response 62 and a user interest biased embedding 64, an example of which is shown in FIG. 6. The processing circuitry 12 can be configured to project the text response 62 (or logits and/or embeddings corresponding thereto) of the MLLM response 60 with the trained projector 50 to form the user-interest-biased image embedding 64 corresponding to the input image 54. The trained projector 50 and the trained adapter layer 48 are trained on pairwise similarity between relational-graph nodes, discussed below. The trained adapter layer can be a low-rank adapter (LoRA) layer, for example. The MLLM-generated response 60 to the embedding-generation instruction text 58 is a semantically detailed description 61 of the input image 54 containing a specialized token 63, shown in FIG. 5. The semantically detailed description 61 is a reasoning statement generated by the MLLM 44, and the specialized token 61 enables the MLLM 42 to transform the reasoning statement and specialized token 61 into the user-interest-biased image embedding 64, via projector 50. The response 60 is returned to the MLLM-based embeddings extractor 38, which requested it. In turn the MLLM-based embeddings extractor 38 passes the response 60 to the relational graph builder 40.

The relational graph builder 40 executed by the processing circuitry 12 is configured to construct a weighted relational graph 66 including a plurality of nodes 68 connected by edges 70, in which each node 68 corresponds to one of the plurality of input images 54 and each edge 70 has a weight 72 determined by pairwise similarity between a user-interest-biased embedding assigned by the trained adapter layer 48 corresponding to each of the respective nodes each edge connects. A weight computation module 40A is provided to perform the pairwise similarity computations between embeddings 69 for each pair of nodes 68 joined by an edge 70. The pairwise similarity may be a cosine similarity, Euclidian distance, Jaccard distance, etc. To construct the weighted relational graph 66, edges 70 with weights 72 that do not exceed a predetermined pairwise similarity threshold are filtered out of the weighted relational graph 66 by a filtering module 40B, thereby forming a plurality of separate connected components 66A, 66B of the weighted relational graph 66. This filtering is shown in FIG. 1, where an “X” is drawn through edges 70 with weights 72 below a filtering threshold of 0.5, and these edges are removed from the graph 66.

The processing circuitry 12 is further configured to perform clustering of the nodes 68 in the weighted relational graph 66 using one or more MLLM-based agent 42, to identify a plurality of clusters 74 based on the user-interests 32. Each MLLM-based agent 42 includes graph traversal and clustering logic 75 that performs the clustering as follows. Applying the graph traversal an clustering logic 75, the performing of the clustering can be accomplished by the MLLM-based agent 42 traversing each node of each connected component and (a) identifying the highest-degree node as a clustering centroid of a current cluster, (b) determining a neighborhood of nodes neighboring the clustering centroid, (c) selecting a candidate neighboring node, (d) evaluating the candidate neighboring node, based on the one or more user-interests, for cluster membership, whereby qualifying candidate neighboring nodes are merged into the current cluster and the edges between disqualifying candidate neighboring nodes and the current cluster are removed, and (e) repeating (a) through (d) until the neighborhood is empty, thereby assigning the neighborhood nodes to one or more clusters. The MLLM agent 42 can be one of a plurality of MLLM-based agents 42 that traverse the connected components in parallel to carry out (a) through (e) until all neighboring nodes are clustered in a respective connected component. Step (d) above can be accomplished by evaluating the semantic similarity of pairwise reasoning statements for each node in a pair of nodes connected by an edge, via the MLLM-based agent 42 and the second instance of the MLLM 44B, to thereby infer binary pseudo labels (e.g., “yes” or “no”) for the user-interest-biased image embeddings. The MLLM-based agent 42 decides whether a candidate neighboring node qualifies for cluster membership according to the binary pseudo label associated with the candidate neighboring node, using the MLLM 44B as a judge. The MLLM-based agent accomplishes this by sending a cluster membership prompt 76 generated by prompt generator 56 to the MLLM 44B, including the second trained adapter layer 52. The MLLM acts as a judge using the second trained adapter layer 52 and generates a response 78. Response 78 includes a binary response 80, typically including one of the binary pseudo labels “yes” or “no”, and a reasoning statement 82. An example of response 78 is shown in FIG. 6.

The MLLM-based agent 42 also can be configured to perform inter-cluster similarity assessments to merge semantically redundant clusters. Whereas steps (a)-(e) above remove low weighted edges from the graph, the merging of semantically similar clusters involves a comparison of a plurality of connected components such as 66A, 66B to determine whether the embedding representations of each entire connected component, as clusters, are sufficiently similar (i.e., within a cluster merging similarity threshold) to merge the two connected components. Typically, this is accomplished by adding at least one edge between the most similar pair of nodes in each respective connected component. This reduces the overall number of the identified clusters 74, thereby simplifying inference time selection of users or content for display, for example.

The processing circuitry is further configured to output the plurality of clusters 74. The outputted clusters 74 can be used for a variety of purposes. In the implementation of FIG. 1, the clusters 74 can be used by algorithm 36 to select content to be displayed to a user and/or to select a user to which content is to be displayed. As discussed above, by matching content to users using clusters 74, the algorithm 36 of the content recommendation engine 34 can avoid reasoning over each individual content item or user, and can instead reason over a cluster 74 of users or a cluster 74 of content items instead, saving processing time. The content recommendation engine 34 is configured to implement the content recommendation algorithm 36 to thereby perform a content recommendation operation by selecting content (e.g., media 22) or a user 28 associated with one of the output clusters 74, to thereby cause the selected content (e.g., media 22) to be served by the content server 20 and displayed or the selected user 28 to receive a display of content (e.g., media 22) via the application program 24 on client device 26. With appropriate prompt design, the content (e.g., media 22) can be grouped according to cluster type to provide diversity, coverage, and serendipity to the content recommendation. This results in a more interesting and relevant selection of content (e.g., media 22) for display to the user 28, as can be demonstrated through increased interactions 30 between the user 28 and the selected content (e.g., media 22).

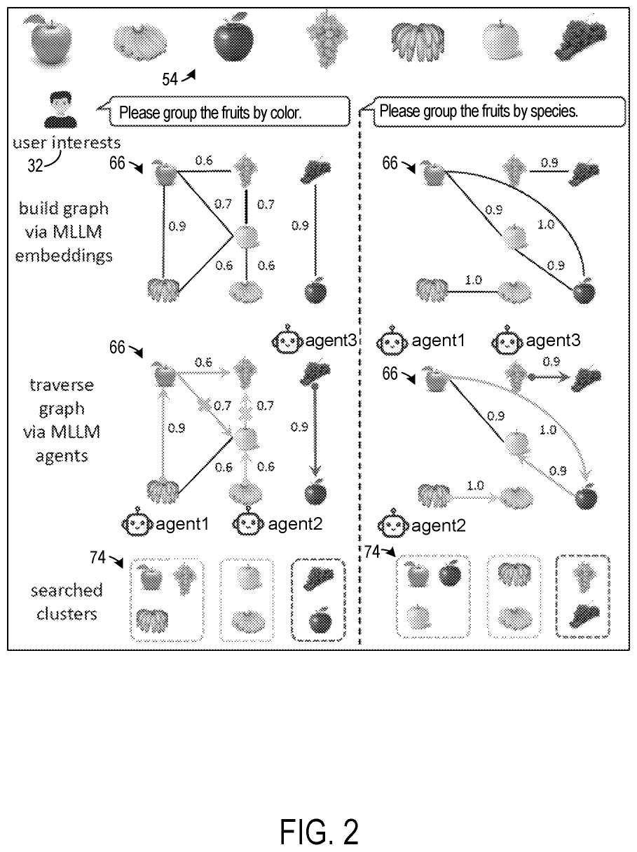

The clustering techniques described above with reference to computing system 10 of FIG. 1 are described in more detail below with reference to FIGS. 2-12, using specific examples such as the clustering of fruit and cards. These examples are not to be understood as limiting, as the clustering techniques described herein are generally applicable to images of a variety of subjects. Further the application of the outputted clusters to a content recommendation engine of a social media platform should also be understood to be merely exemplary as the clustering can be applied to any scenario in which images are to be clustered by user interests, and thus numerous other potential applications exist.

FIG. 2 graphically illustrates the construction of the relational graph 66 by computing system 10 with embeddings as nodes and pairwise node relationships as weighted edges (discussed below). In FIG. 2, multiple MLLM agents 42 are applied to comprehensively traverse the relational graph to search for clusters. By selecting high-degree nodes as starting points (which also serve as initial clusters), the MLLM agents 42 iteratively expand the clusters through a decision-making process. At each step, they assess the membership of neighboring nodes in existing clusters according to user clustering preferences expressed in the user interests 32, and then adjust the cluster boundaries accordingly. Leveraging the advanced contextual understanding of MLLM 44, the method according to the present disclosure produces clusters 74 that more accurately reflect user-defined criteria (user interests 32) compared to prior CLIP-based approaches.

A naive approach to construct the relational graph is to fully connect all nodes. However, this results in an overly dense graph, significantly increasing the traversal steps for agents and undermining the efficiency of cluster searching. To reduce computational overhead, a weighted relational graph 66 is constructed where edge weights are determined by the similarities between user-interest-biased embeddings 64 extracted by MLLM 44A. By filtering out a large number of weakly connected edges based on embedding similarity, the agents' traversal paths are shortened, allowing them to traverse the graph more efficiently. As discussed in more detail below in relation to FIG. 5, for each image 54, the MLLM 44B generates a user-interest-based description 60A containing an embedding token 63, whose hidden states are projected to form the data point's embedding 64. Compared to CLIP-based embeddings, MLLM-based ones dynamically adapt to diverse and nuanced user interests through comprehensive contextual reasoning, preserving primarily valid edges and resulting in a sparser relational graph.

The method according to the present disclosure is evaluated on five publicly available visual datasets commonly used for multiple clustering tasks, and the results demonstrate its state-of-the-art performance. For instance, the method according to the present disclosure achieves NMI scores of 0.9667 and 0.9481 on the Card Order and Card Suits benchmarks, respectively, surpassing the current state-of-the-art model by over 140%. The present disclosure is a multiple clustering method built on MLLMs, and provides a promising approach to unify personalized clustering and agent-based searching that can be applied to in a variety of fields, including content recommendation. Highlights of the present disclosure can be summarized as follows.
1. An agent-centric personalized clustering framework is introduced, leveraging multi-modal large language models (MLLMs) as agents to explore a relational graph extensively to identify clusters that accurately reflect user-specific interests.
2. To enhance efficiency, a relational graph is constructed using MLLM-generated embeddings that are tailored to user interests. By filtering out weakly connected edges based on embedding similarity, the agents' traversal paths are significantly shortened during the search process.
3. Experimental results demonstrate that the approach of the present disclosure achieves substantial improvements on multiple benchmarks, demonstrating the effectiveness of the method according to the present disclosure.

Now, the proposed agent-centric personalized multiple clustering framework implemented by computing system 10 described above will be introduced in more detail, with specific examples and comparisons of results to prior approaches. The framework is introduced with an overview, followed by a detailed description of each component: agent-centric graph traversal, MLLM-based graph construction, and agent-based membership assessment.

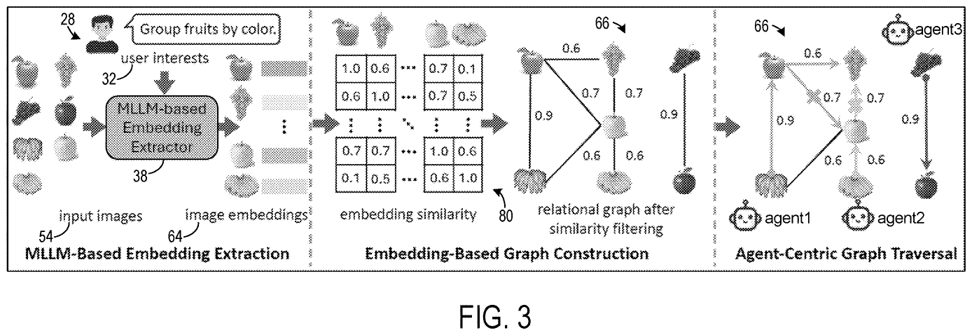

As graphically illustrated in FIG. 3, the framework implemented by computing system 10 begins by extracting image embeddings 64 using MLLM-based embedding extractor 38 as discussed above, tailoring representations to user interests 32. A similarity matrix 80 is then computed from these embeddings 64 to construct a relational graph 66, where a large number of weakly connected edges 70 are filtered out based on embedding similarity, expressed as weights 72. Finally, MLLM-based agents 42 traverse this graph 66 to search for clusters 74 aligned with user clustering preferences (expressed as user interests 32), with each agent 42 specializing in a different cluster 74. This agent-centric approach produces clusters 74 that better adhere to user-defined criteria in the user interests 32 than those obtained from prior techniques, such as CLIP-based representations.

### Agent-Centric Graph Traversal

In this section, the agent-centric graph traversal approach of the present disclosure for cluster discovery is described. The approach starts with a relational graph [symbol] ={ [symbol] ,ε, [symbol] } constructed as detailed in Sec 3.3, where each node u∈ [symbol] represents a data point, and each edge {u,v}∈ε carries a weight w(u,v)∈ [symbol] indicating a precomputed, embedding-based similarity score between u and v. Leveraging multi-modal large language models (MLLMs) as agents, [symbol] is traversed to search for clusters [symbol] aligned with user interests T.

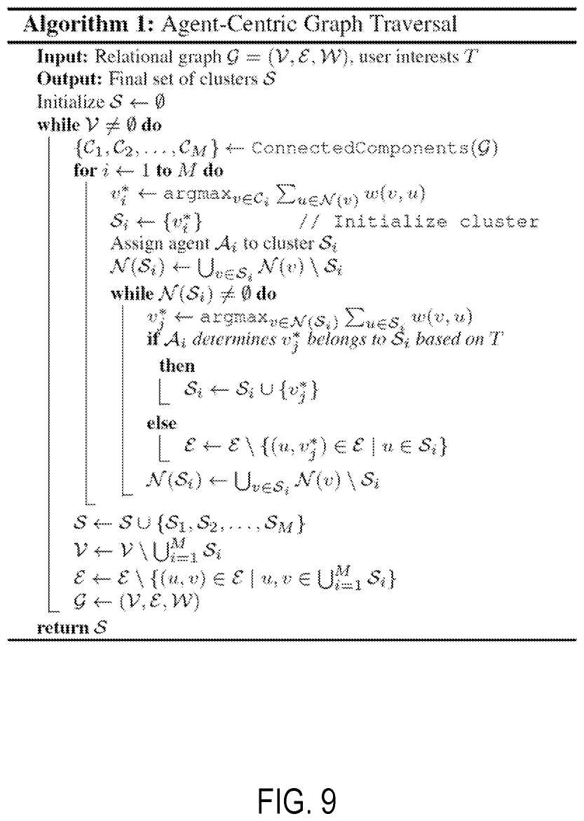

As outlined in Algorithm 1 of FIG. 9 the first step is to identify the connected components of the relational graph [symbol] , resulting in M components:

$${\{ {\text{?}}_{i} \}}_{i = 1}^{M} = ConnectedComponents ( 𝒢 ) . \qquad ( 1 )$$

For each connected component [symbol] , the highest degree node

$${v}_{i}^{*}$$

is selected and designated as the seed for an initial cluster [symbol] ᵢ as follows:

$${v}_{i}^{*} = arg \text{?} {\sum }_{u ∈ 𝒩 ( v )} w ( v , u ) , {\text{?}}_{i} = \{ {v}_{i}^{*} \} , \qquad ( 2 )$$

where [symbol] (v) is the neighborhood of node v. Then, an MLLM-based agent [symbol] is assigned to each initial cluster [symbol] ᵢ, resulting in a total of M agents, denoted as

$${\{ {\text{?}}_{i} \}}_{i = 1}^{M} .$$

Each agent [symbol] iteratively expands its corresponding cluster [symbol] ᵢ by evaluating the membership of its neighboring nodes in [symbol] ᵢ based on user interests T.

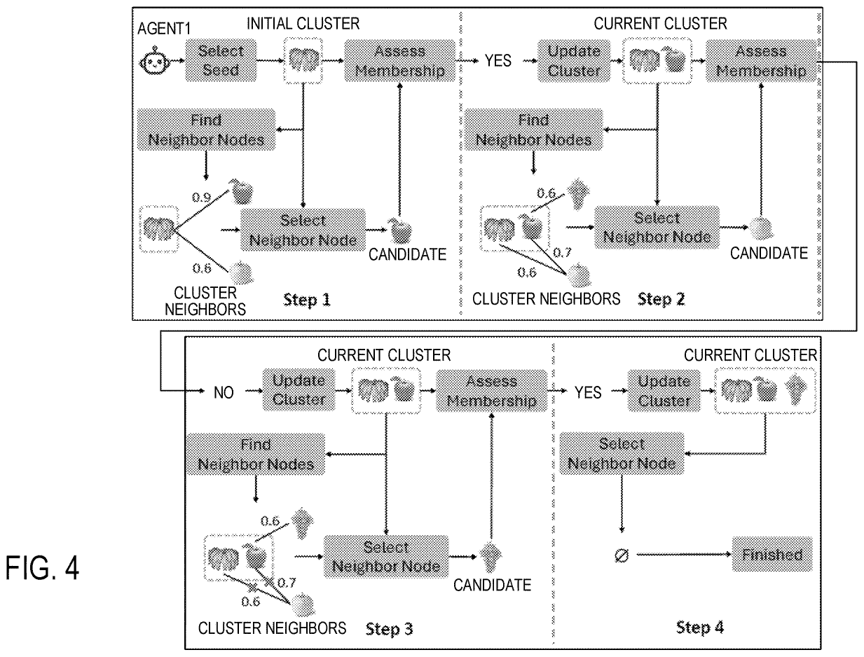

As shown in FIG. 4 and Algorithm 1 of FIG. 9, at each step, the agent [symbol] first determines the neighborhood of the current cluster [symbol] ᵢ, defined as:

$$𝒩 ( {\text{?}}_{i} ) = {⋃}_{v ∈ {\text{?}}_{i}} 𝒩 ( v ) \backslash {\text{?}}_{i} \qquad ( 3 )$$

Next, the agent selects a candidate neighboring node

$${v}_{j}^{*}$$

from [symbol] ( [symbol] ᵢ) that exhibits the highest weighted connectivity to [symbol] ᵢ, given by:

$${v}_{j}^{*} = arg \text{?} \text{?} w ( v , u ) . \qquad ( 4 )$$

The agent then assesses whether

$${v}_{j}^{*}$$

should be included in [symbol] ᵢ based on user-defined criteria, as detailed below. If the candidate node

$${v}_{j}^{*}$$

is deemed a valid member, it is merged into the current cluster [symbol] ᵢ, updating [symbol] ᵢ as follows:

$${\text{?}}_{i} ← {\text{?}}_{i} ⋃ \{ {v}_{j}^{*} \} . \qquad ( 5 )$$

Otherwise, the edges between the candidate node

$${v}_{j}^{*}$$

and the current cluster [symbol] ᵢ are removed from the edge set ε, yielding an updated edge set:

$$ℰ ← ℰ \backslash \{ ( u , {v}_{j}^{*} ) ∈ ℰ \vert u ∈ {\text{?}}_{i} \} . \qquad ( 6 )$$

The process from Eq. (3) to Eq. (6) is repeated until the neighborhood [symbol] ( [symbol] ᵢ) is empty, at which point the final cluster [symbol] ᵢ is determined.

The M agents,

$${\{ {\text{?}}_{i} \}}_{i = 1}^{M} ,$$

traverse the graph [symbol] in parallel, each producing a cluster [symbol] ᵢ, resulting in a total of M clusters,

$${\{ {\text{?}}_{i} \}}_{i = 1}^{M} .$$

The cluster set [symbol] (initially empty), node set [symbol] , and edge set ε are then updated as follows:

$$\text{?} ← \text{?} ⋃ {\{ {\text{?}}_{i} \}}_{i = 1}^{M} , 𝒱 ← 𝒱 \backslash {⋃}_{i = 1}^{M} {\text{?}}_{i} , \qquad ( 7 )$$

$$ℰ ← ℰ \backslash \{ ( u , v ) ∈ ℰ \vert u , v ∈ {⋃}_{i = 1}^{M} {\text{?}}_{i} \}$$

The process from Eq. (1) to Eq. (7) is repeated iteratively until the node set V becomes empty, at which point the final cluster set [symbol] is obtained.

### MLLM-Based Graph Construction

The construction of the relational graph [symbol] ={ [symbol] ,ε, [symbol] } used for agent traversal is detailed here. Each node u∈ [symbol] corresponds to a data point. Each edge (u,v)∈ε is assigned a weight w(u,v)∈W, determined by the similarity between the embeddings [symbol] (u) and [symbol] (v). These embeddings are extracted by the MLLM for nodes u and v based on user interests T, as described below.

As shown in FIG. 5, the first step is to design an embedding generation instruction text 58 based on user interests T. For example, if the user intends to cluster input images by “fruit color”, the instruction is formulated as: “Describe the color of the fruit in the provided image in detail and generate <embedding> based on the description.” Then, the image u and the embedding instruction are provided as input to the MLLM, which responds with a reasoning statement followed by an <embedding> token. For instance, it may generate: “The fruit in the image is a glossy, vibrant red apple with subtle shading and a contrasting green leaf. Embedding: <embedding>.” The hidden state of the <embedding> token 63 in the output is then projected by linear projector 50 to obtain the user-interest-biased embedding [symbol] (u) 64.

As shown in FIG. 2, after obtaining the embeddings [symbol] (u) and [symbol] (v), the edge weight w(u,v) is computed as:

$$w ( u , v ) = σ ( β \cdot \text{?} {( u )}^{T} \text{?} ( v ) ) , \qquad ( 8 )$$

where β is a learnable logit scale, and σ denotes the sigmoid function. An edge (u,v) is retained in the edge set E only if its weight w(u,v) exceeds a predefined threshold τ. The MLLM is fine-tuned using an adapter layer 48 (e.g., LoRA), with a training data set of images labeled with labels generated by GPT-4. For generation training, GPT-4's descriptions of images under user interests T are used as labels, appending a <embedding> token. For embedding training, the similarity w(u,v) is supervised based on GPT-4's comparison of nodes u and v under user interests T. The weights of the pre-trained MLLM are frozen during LoRA training. The linear projector is trained at the same time as the LoRA training (see fire icons in FIG. 5 indicating trainable weights), in an end-to-end training process.

### Agent-Based Membership Assessment

This section describes how each MLLM agent [symbol] ᵢ 42 assesses whether a candidate node

$${v}_{j}^{*}$$

should be included in the current cluster [symbol] ᵢ based on user interests T. As shown in FIG. 6, first, K representative nodes are selected from [symbol] ᵢ, specifically those with the highest degree in [symbol] ᵢ, as follows:

$${ℛ}_{i} = arg \text{?} {\sum }_{v ∈ R} \text{?} w ( v , u ) , \qquad ( 9 )$$

where [symbol] ᵢ is the set of the selected representative nodes, which is used to represent the current cluster [symbol] ᵢ for agent-based membership assessment.

Then, a membership assessment instruction is designed for inclusion in cluster membership prompt 76 discussed above, based on user interests T. For example, if the user intends to cluster input images by “fruit color”, the instruction is formulated as: “Determine whether the candidate fruit should be included in the existing fruit cluster based on color similarity. Respond with ‘yes’ or ‘no’.” Next, the images along with the membership instruction into the agent [symbol] ᵢ, which generates a reasoning statement followed by a yes or no response. For example, it may generate: “The current cluster consists of green fruits, while the candidate apple is yellowish. Based on color similarity, it should not be included. The answer is ‘no’.” The boundary of the current cluster [symbol] ᵢ is refined based on the assessment of the agent [symbol] ᵢ, as outlined in Eqs. (5) and (6). For generation training, the MLLM-based agent [symbol] ᵢ is fine-tuned using the second adapter layer 52 (e.g., LoRA), where the corresponding membership assessment generated by GPT-4 is used as predicted labels and compared to ground truth labels for the second adapter layer training dataset. The weights of the MLLM are frozen during this second adapter layer training phase.

### EXPERIMENTS

### Datasets

Experiments were conducted on five multiple-clustering benchmarks, including Card, CMUface, Fruit, Fruit360, and CIFAR10-MC. The Card dataset contains 8,029 images of playing cards, supporting two clustering schemes: order (from Ace to King) and suits (clubs, diamonds, hearts, spades). CMUface comprises 640 facial images with multiple clustering criteria, including face pose (left, right, straight, up), identity (20 people), presence of sunglasses (with, without), and emotion (angry, sad, happy, neutral). Fruit consists of 105 fruit images, which can be clustered by species (apples, bananas, grapes) or color (green, red, yellow). Fruit360 extends the Fruit dataset with 4,856 images annotated for both species (apple, banana, grape, cherry) and color (green, red, yellow, burgundy). CIFAR10-MC includes 60,000 images with two clustering dimensions: type (transportation, animals) and environment (land, air, water).

### Evaluation Metrics

Clustering performance was evaluated using two widely adopted metrics: Normalized Mutual Information (NMI) and Rand Index (RI). NMI quantifies mutual dependence between predicted and ground-truth clusters, normalized for cluster size variations. RI measures agreement between predicted and true partitions by considering correctly grouped and separated sample pairs. Both metrics range from 0 to 1, with higher values indicating better alignment with the ground truth.

### Implementation Details

LLaVA was adopted as the MLLM model of the present disclosure, using Qwen27B as the language model. To train the MLLM-based embedding extractor, hard negative mining was employed for data sampling, selecting 1,024 data pairs with the highest similarity entropy each epoch. GPT-4 then was used to evaluate the data pairs' similarities based on user interests T, assigning labels accordingly. The embedding extractor was trained for 50 epochs. To train the MLLM-based agent, a 1,024-node subgraph was uniformly sampled from the relational graph. GPT-4 then traversed this subgraph and assessed neighboring node memberships, providing labels accordingly. The agent was trained for 50 epochs. Only the language model was fine-tuned with LoRA, in this example. AdamW was used for optimization with a learning rate of 1e⁻⁵, following a cosine decay schedule. In the relational graph construction. The embedding similarity threshold r for filtering the weakly connected edges was set to 0.6.

### Results

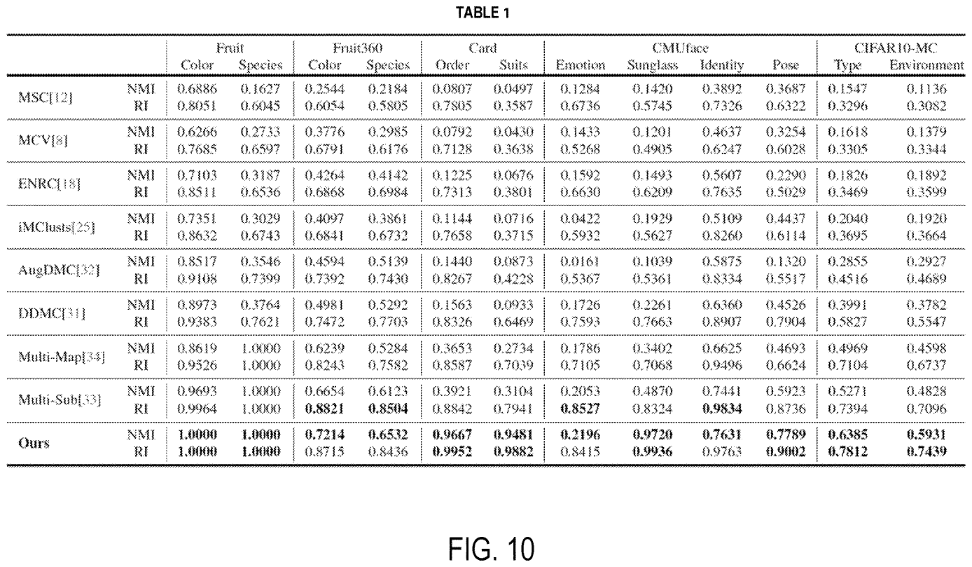

As shown in Table 1 of FIG. 10, the method according to the present disclosure outperforms state-of-the-art models across all multiple clustering benchmarks. On the Fruit dataset, it achieves perfect NMI and RI scores (1.0000) for both color-based and species-based clustering, outperforming all other methods. On the Fruit360 dataset, for color-based clustering, the method according to the present disclosure achieves an NMI of 0.7214, surpassing Multi-Map by 15.6% and Multi-Sub by 8.4%. For species-based clustering, it achieves an NMI of 0.6532, outperforming Multi-Map by 24.3% and Multi-Sub by 6.7%. On the CIFAR10-MC dataset, for type-based clustering, the method according to the present disclosure reaches an NMI of 0.6385 and an RI of 0.7812, surpassing Multi-Sub by 21.1% in NMI and 5.7% in RI. For environment-based clustering, it achieves an NMI of 0.5931 and an RI of 0.7439, surpassing Multi-Sub by 22.8% in NMI and 4.8% in RI.

On the Card dataset, for order-based clustering, the method according to the present disclosure achieves an NMI of 0.9667 and an RI of 0.9952, surpassing Multi-Sub by 146.5% in NMI and 12.6% in RI. For suits-based clustering, it achieves an NMI of 0.9481 and an RI of 0.9882, outperforming Multi-Sub by 205.4% in NMI and 24.4% in RI. On the CMUface dataset, for sunglass-based clustering, the method according to the present achieves an NMI of 0.9720 and an RI of 0.9936, surpassing Multi-Sub by 99.6% in NMI and 19.4% in RI. For pose-based clustering, it achieves an NMI of 0.7789 and an RI of 0.9002, surpassing Multi-Sub by 31.5% in NMI and 3.0% in RI. These significant improvements highlight the effectiveness of the agent-centric clustering framework of the present disclosure in capturing user interests (e.g., order, suits, sunglass, pose) with advanced contextual understanding from MLLMs, while minimizing interference from irrelevant information.

### Ablation Studies

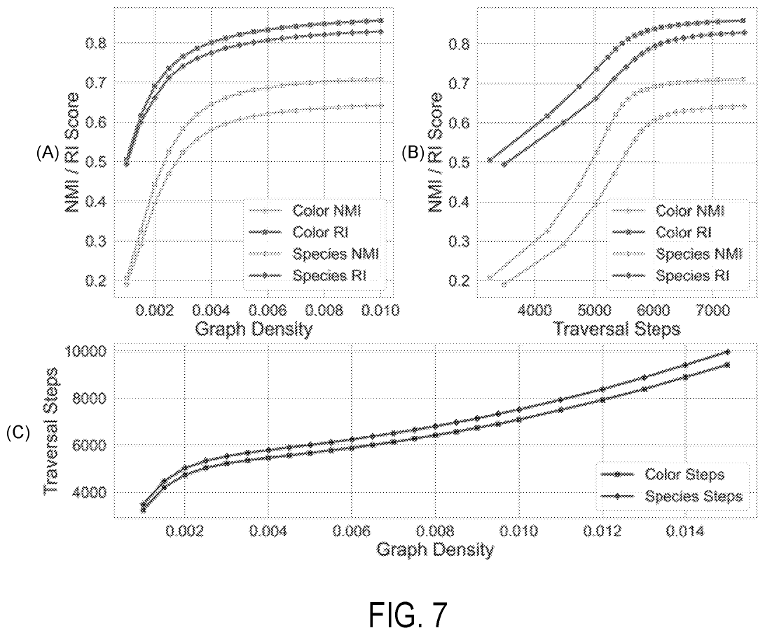

Density of Relational Graph. To assess the impact of graph density on agent graph traversal, the embedding similarity threshold z was varied to generate relational graphs with different densities. The agents then traversed these graphs following Algorithm 1 of FIG. 9 to obtain comparative results. The experiments were conducted on the Fruit360 dataset. As shown in FIG. 7, increasing the graph density (i.e., relaxing the threshold z) steadily improved the metrics of both color-based and species-based clustering (NMI and RI) until they began to saturate. For example, the Color RI (greensquare) and Species RI (green-diamond) curves quickly rise and plateau around 0.87 and 0.84, while the Color NMI (orange-square) and Species NMI (orange-diamond) converge near 0.72 and 0.65. This indicates that, once enough edges are retained to form connected subgraphs of semantically similar nodes, further densification of the graph yields only marginal gains in clustering accuracy.

However, the improved clustering performance comes at the expense of increased traversal cost. As the graph becomes denser, agents need to explore far more edges to accurately determine which nodes are true neighbors. In particular, the traversal-steps curve (dark blue) rises from roughly 3000 to nearly 10000 as the graph density is increased from 0.001 to 0.015, reflecting significantly greater computational overhead. Consequently, a moderate value of r can strike a balance: the NMI/RI curves plateau beyond a certain graph density, so pushing the threshold r to achieve this point improves efficiency without sacrificing meaningful gains in clustering performance. These results highlight the advantage of using MLLM-based embeddings for constructing the relational graph. By selectively pruning weakly connected edges with low embedding similarities, agents can avoid exhaustive searches in graph regions unlikely to contain relevant neighbors. Meanwhile, the context-aware nature of MLLM embeddings helps preserve essential edges between semantically similar nodes, ensuring high coherence with user interests while requiring fewer traversal steps than a fully dense graph.

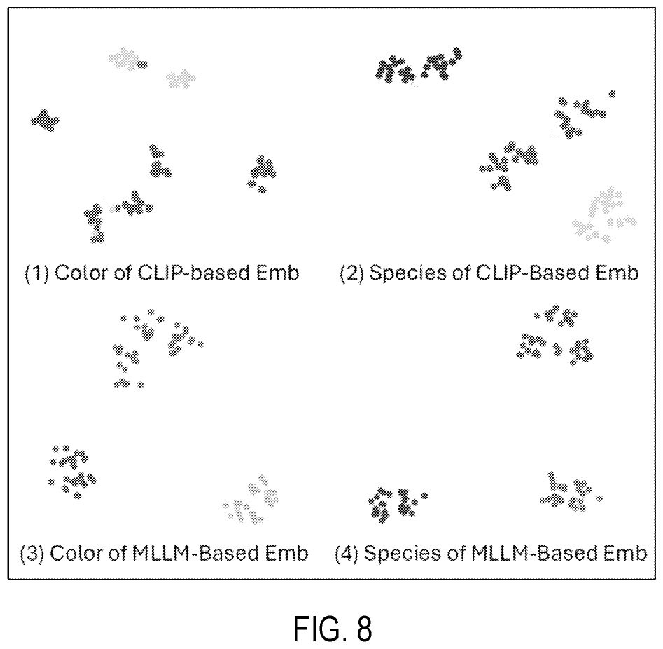

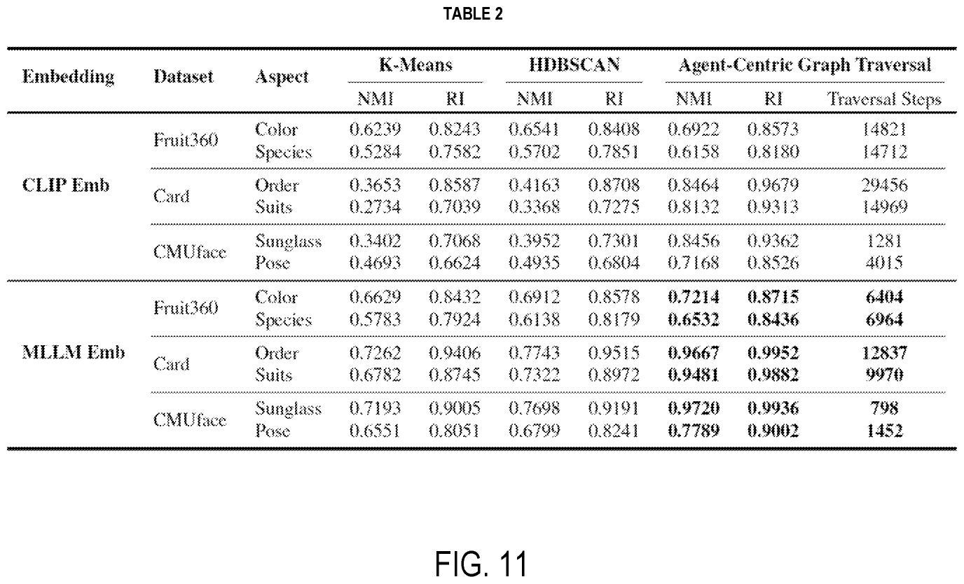

MLLM-based vs. CLIP-based Embeddings. The effectiveness of the MLLM-based embeddings of the present disclosure is validated by comparing them with CLIP-based ones across various clustering methods. Multi-Map is used as the CLIP baseline, as both approaches decouple embedding extraction from clustering, enabling controlled ablations. As shown in Table 2 of FIG. 11, MLLM-based embeddings consistently outperform CLIP-based ones across all clustering methods. For instance, on the CMUface dataset (“Sunglass” aspect), MLLM-based embeddings improve NMI from 0.3402, 0.3952, and 0.8456 to 0.7193, 0.7698, and 0.9720 for K-means, HDBSCAN and agent-centric clustering, respectively. These gains highlight the strong contextual reasoning capabilities of MLLMs, enabling them to better capture nuanced, user-specific preferences than CLIP. FIG. 8 further illustrates this via a t-SNE visualization on the Fruit dataset: MLLM-based embeddings (bottom row) form compact, well-separated clusters, whereas CLIP-based embeddings (top row) show higher intra-cluster variance, especially in color-based partitioning. Thus, MLLM-based embeddings better capture user interests (e.g., color, species), improving clustering performance.

Furthermore, MLLM embeddings significantly reduce the number of traversal steps required for the convergence of agent-centric clustering. For instance, on the Fruit360 dataset (“Color” aspect), the agent traversal completes in 6404 steps by MLLM-based embeddings, roughly half of the 14821 steps needed by CLIP-based embeddings. This efficiency arises because MLLM-based embeddings produce a more sparse relational graph-many noise edges are correctly pruned due to lower similarities. Consequently, the agents can traverse fewer edges to expand clusters according to user clustering preferences, leading to both higher quality and more efficient clustering.

Agent-Centric Clustering vs. K-Means & HDBSCAN. The effectiveness of the agent-centric graph traversal clustering of the present disclosure is evaluated against classical K-Means and HDBSCAN. As shown in Table 2 of FIG. 11, the agent-centric approach consistently improves both NMI and RI across all datasets and embedding types. For instance, on the Card dataset (“Order” aspect) with MLLM-based embeddings, agent-centric clustering achieves an NMI of 0.9667, surpassing K-Means (0.7262) and HDBSCAN (0.7743). The gains are even more pronounced with CLIP-based embeddings. For example, on the Card dataset (“Order” aspect) with CLIP-based embeddings, agent-centric clustering achieves an NMI of 0.8464, outperforming K-Means (0.3653) and HDBSCAN (0.4163). Moreover, the agent-centric method often requires significantly fewer traversal steps with MLLM-based embeddings than with CLIP-based ones (as discussed above), enhancing efficiency.

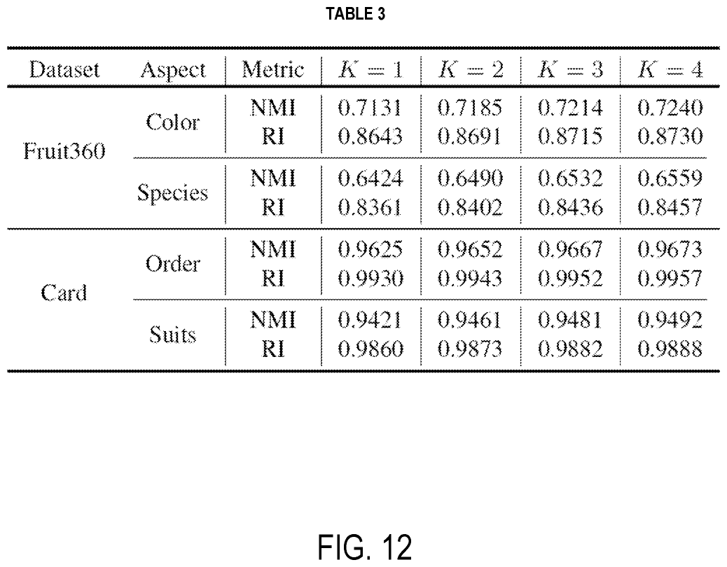

Number of Representative Nodes. Table 3 of FIG. 12 shows the effect of varying K on clustering performance (NMI and RI). Using a single representative node may fail to capture the cluster's diversity, leading to lower performance. Increasing K improves both metrics by better reflecting the cluster's structure, although gains beyond three or four representatives are typically modest. Thus, a moderate K strikes the best balance between capturing diversity and avoiding redundant information.

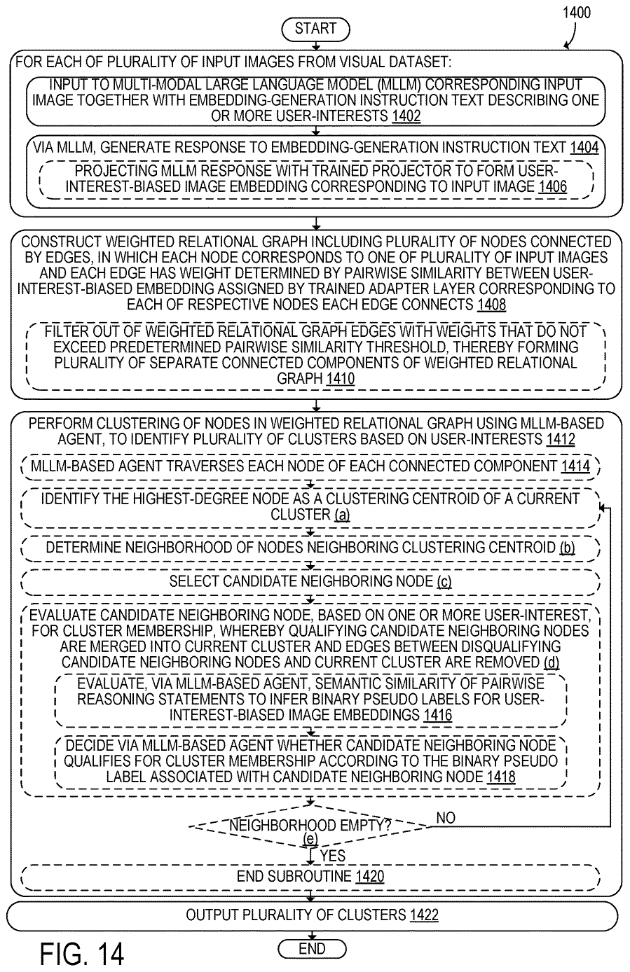

FIG. 14 illustrates a computerized method 1400 user-interest-tailored clustering from a visual dataset using an MLLM, according to one implementation of the present disclosure. Method 1400 can be implemented using the hardware and software components described in relation to FIGS. 1-13 above, or using other suitable components. Method 1400 includes, for each of a plurality of input images from the visual dataset, at 1402, inputting to a multi-modal large language model (MLLM) a corresponding input image together with embedding-generation instruction text describing one or more user-interests, and at 1404, via the MLLM, generating a response to the embedding-generation instruction text.

It will be appreciated that the MLLM can include a trained projector, and the trained adapter layer can be trained on pairwise similarity between relational-graph nodes. In this implementation, as shown at 1406, the clustering method further comprises projecting the MLLM response with the trained projector to form a user-interest-biased image embedding corresponding to the input image.

Method 1400 further includes, at 1408, constructing a weighted relational graph including a plurality of nodes connected by edges, in which each node corresponds to one of the plurality of input images and each edge has a weight determined by pairwise similarity between a user-interest-biased embedding assigned by a trained adapter layer corresponding to the each of the respective nodes each edge connects. As shown at 1410, constructing the weighted relational graph can include filtering out of the weighted relational graph edges with weights that do not exceed a predetermined pairwise similarity threshold, thereby forming a plurality of separate connected components of the weighted relational graph.

Method 1400 further includes, at 1412, performing clustering of the nodes in the weighted relational graph using an MLLM-based agent, to identify a plurality of clusters based on the user-interests. At 1414, it is shown that performing of the clustering can be accomplished by the MLLM-based agent traversing each node of each connected component and (a) identifying the highest-degree node as a clustering centroid of a current cluster, (b) determining a neighborhood of nodes neighboring the clustering centroid, (c) selecting a candidate neighboring node, (d) evaluating the candidate neighboring node, based on the one or more user-interest, for cluster membership, whereby qualifying candidate neighboring nodes are merged into the current cluster and the edges between disqualifying candidate neighboring nodes and the current cluster are removed, and (e) repeating (a) through (d) until the neighborhood is empty, thereby assigning the neighborhood nodes to one or more clusters.

Further, the MLLM agent can be one of a plurality of MLLM-based agents each of which traverses a respective connected component in parallel to carry out (a) through (e) until all neighboring nodes are clustered in a respective connected component.

It will be appreciated that the MLLM-generated response to the embedding-generation instruction text can include a semantically detailed description of the input image containing a specialized token, the semantically detailed description being a reasoning statement generated by the MLLM. Such a specialized token enables the MLLM to transform the reasoning statement into the user-interest-biased image embedding. In such an implementation, evaluation of the candidate neighboring node at (d) can include, at 1416, evaluating, via the MLLM-based agent, semantic similarity of pairwise reasoning statements to infer binary pseudo labels for the user-interest-biased image embeddings, and further can include, at 1418 deciding via the MLLM-based agent whether a candidate neighboring node qualifies for cluster membership according to the binary pseudo label associated with the candidate neighboring node.

At 1420, once all neighborhoods traversed by all agents are empty, the subroutine ends. At 1422, the method includes outputting the plurality of clusters identified by the agents.

It will be appreciated that the method may further include performing a content recommendation operation by selecting content or a user associated with one of the output clusters, to thereby cause the selected content to be displayed or the selected user to receive a display of content. Alternatively, the clusters may be used in a variety of other applications and fields, as discussed above.

In the above-described systems and methods, an agent-centric clustering framework is proposed that utilizes MLLMs to traverse relational graphs and identify clusters tailored to user interests. Leveraging MLLMs' reasoning capabilities, the method according to the present disclosure better aligns clusters with user-defined criteria, surpassing CLIP embedding-based techniques. For efficiency, relational graphs are built using user-interest-biased embeddings derived from MLLMs, guiding agents along optimized paths by filtering weak connections. Experiments show that the approach of the present disclosure achieves state-of-the-art performance across multiple benchmarks, validating its effectiveness. The agent-centric clustering enables the customization of clustering criteria and can be extensively applied in industrial scenarios such as content recommendation, search, and graph mining.

In some embodiments, the methods and processes described herein may be tied to a computing system of one or more computing devices. In particular, such methods and processes may be implemented as a computer-application program or service, an application-programming interface (API), a library, and/or other computer-program product.

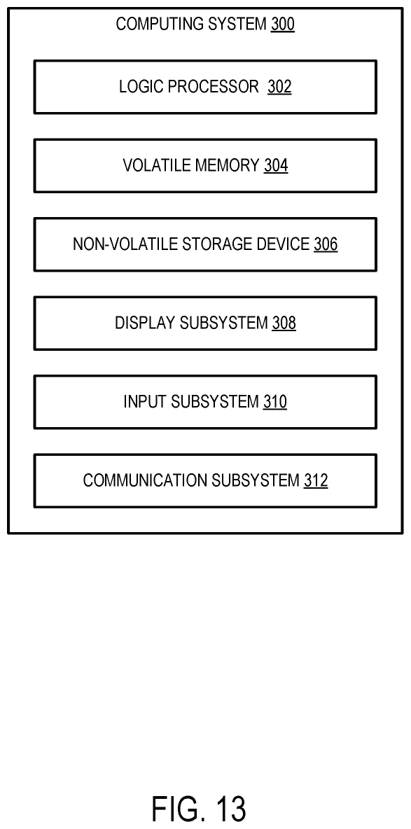

FIG. 13 schematically shows a non-limiting embodiment of a computing system 300 that can enact one or more of the methods and processes described above. Computing system 300 is shown in simplified form. Computing system 300 may embody the computing system 1 described above and illustrated in FIG. 1, 2, 3, 4, or, 5. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 13.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. One aspect provides a computing system. The computing system comprises processing circuitry and associated memory storing instructions that when executed by the processing circuitry, cause the processing circuitry to, for each of a plurality of input images, input to a multi-modal large language model (MLLM) a corresponding input image together with embedding-generation instruction text describing one or more user-interests, and via the MLLM, generate a response to the embedding-generation instruction text, construct a weighted relational graph including a plurality of nodes connected by edges, in which each node corresponds to one of the plurality of input images and each edge has a weight determined by pairwise similarity between a user-interest-biased embedding corresponding assigned by a trained adapter layer to each of the respective nodes each edge connects, perform clustering of the nodes in the weighted relational graph using an MLLM-based agent, to identify a plurality of clusters based on the user-interests, and output the plurality of clusters. In this aspect, additionally or alternatively, the MLLM includes a trained projector, the trained adapter layer is trained on pairwise similarity between relational-graph nodes, and the processing circuitry is further configured to project the MLLM response with the trained projector to form the user-interest-biased image embedding corresponding to the input image. In this aspect, additionally or alternatively, to construct the weighted relational graph, edges with weights that do not exceed a predetermined pairwise similarity threshold are filtered out of the weighted relational graph, thereby forming a plurality of separate connected components of the weighted relational graph. In this aspect, additionally or alternatively, the performing of the clustering is accomplished by the MLLM-based agent traversing each node of each connected component and (a) identifying the highest-degree node as a clustering centroid of a current cluster, (b) determining a neighborhood of nodes neighboring the clustering centroid, (c) selecting a candidate neighboring node, (d) evaluating the candidate neighboring node, based on the one or more user-interests, for cluster membership, whereby qualifying candidate neighboring nodes are merged into the current cluster and the edges between disqualifying candidate neighboring nodes and the current cluster are removed, and repeating (a) through (d) until the neighborhood is empty, thereby assigning the neighborhood nodes to one or more clusters. In this aspect, additionally or alternatively, the MLLM agent is one of a plurality of MLLM-based agents each of which traverses a respective connected component in parallel to carry out (a) through (e) until all neighboring nodes are clustered in a respective connected component. In this aspect, additionally or alternatively, the MLLM-based agent performs inter-cluster similarity assessments to merge semantically redundant clusters. In this aspect, additionally or alternatively, the MLLM-generated response to the embedding-generation instruction text is a semantically detailed description of the input image containing a specialized token, the semantically detailed description being a reasoning statement generated by the MLLM, the specialized token enabling the MLLM to transform the reasoning statement into the user-interest-biased image embedding. In this aspect, additionally or alternatively, semantic similarity of pairwise reasoning statements is evaluated via the MLLM-based agent to infer binary pseudo labels for the user-interest-biased image embeddings, and the MLLM-based agent decides whether a candidate neighboring node qualifies for cluster membership according to the binary pseudo label associated with the candidate neighboring node. In this aspect, additionally or alternatively, the trained adapter layer is a low-rank adapter (LoRA) layer. In this aspect, additionally or alternatively, the processing circuitry is further configured to perform a content recommendation operation by selecting content or a user associated with one of the output clusters, to thereby cause the selected content to be displayed or the selected user to receive a display of content. In this aspect, additionally or alternatively, the content is grouped according to cluster type, to provide diversity, coverage, and serendipity to the content recommendation.

Another aspect provides a method of user-interest-tailored clustering from a visual dataset. The method comprises, for each of a plurality of input images from the visual dataset, inputting to a multi-modal large language model (MLLM) a corresponding input image together with embedding-generation instruction text describing one or more user-interests, and via the MLLM, generating a response to the embedding-generation instruction text. The method further comprises constructing a weighted relational graph including a plurality of nodes connected by edges, in which each node corresponds to one of the plurality of input images and each edge has a weight determined by pairwise similarity between a user-interest-biased embedding assigned by a trained adapter layer corresponding to the each of the respective nodes each edge connects, performing clustering of the nodes in the weighted relational graph using an MLLM-based agent, to identify a plurality of clusters based on the user-interests, and outputting the plurality of clusters. In this aspect, additionally or alternatively, the MLLM includes a trained projector, the trained adapter layer is trained on pairwise similarity between relational-graph nodes, and the clustering method further comprises projecting the MLLM response with the trained projector to form a user-interest-biased image embedding corresponding to the input image. In this aspect, additionally or alternatively, constructing the weighted relational graph includes filtering out of the weighted relational graph edges with weights that do not exceed a predetermined pairwise similarity threshold, thereby forming a plurality of separate connected components of the weighted relational graph. In this aspect, additionally or alternatively, the performing of the clustering is accomplished by the MLLM-based agent traversing each node of each connected component and (a) identifying the highest-degree node as a clustering centroid of a current cluster, (b) determining a neighborhood of nodes neighboring the clustering centroid, (c) selecting a candidate neighboring node, (d) evaluating the candidate neighboring node, based on the one or more user-interest, for cluster membership, whereby qualifying candidate neighboring nodes are merged into the current cluster and the edges between disqualifying candidate neighboring nodes and the current cluster are removed, and repeating (a) through (d) until the neighborhood is empty, thereby assigning the neighborhood nodes to one or more clusters. In this aspect, additionally or alternatively, the MLLM agent is one of a plurality of MLLM-based agents each of which traverses a respective connected component in parallel to carry out (a) through (e) until all neighboring nodes are clustered in a respective connected component. In this aspect, additionally or alternatively, the MLLM-generated response to the embedding-generation instruction text is a semantically detailed description of the input image containing a specialized token, the semantically detailed description being a reasoning statement generated by the MLLM, the specialized token enabling the MLLM to transform the reasoning statement into the user-interest-biased image embedding. In this aspect, additionally or alternatively, the method further comprises evaluating, via the MLLM-based agent, semantic similarity of pairwise reasoning statements to infer binary pseudo labels for the user-interest-biased image embeddings, and deciding via the MLLM-based agent whether a candidate neighboring node qualifies for cluster membership according to the binary pseudo label associated with the candidate neighboring node. In this aspect, additionally or alternatively, the method further comprises performing a content recommendation operation by selecting content or a user associated with one of the output clusters, to thereby cause the selected content to be displayed or the selected user to receive a display of content.

Another aspect provides a computing system. The computing system comprises processing circuitry and associated memory storing instructions that when executed by the processing circuitry, cause the processing circuitry to, for each of a plurality of input images, input to a multi-modal large language model (MLLM) a corresponding input image together with embedding-generation instruction text describing one or more user-interests, wherein the MLLM includes a trained projector and a trained adapter layer trained on pairwise similarity between relational-graph nodes, via the MLLM generate a response to the embedding-generation instruction text, and project the MLLM response with the trained projector to form a user-interest-biased image embedding corresponding to the input image. The instructions, when executed by the processing circuitry, further cause the processing circuitry to construct a weighted relational graph including a plurality of nodes connected by edges, in which each node corresponds to one of the plurality of input images and each edge is each a weight determined by pairwise similarity between the user-interest-biased embeddings assigned by the trained adapter layer corresponding to the respective nodes each edge connects, and filter out of the weighted relational graph edges with weights that do not exceed a predetermined pairwise similarity threshold, leaving a plurality of separate connected components of the weighted relational graph, perform clustering of the nodes in the weighted relational graph using an MLLM-based agent, to identify a plurality of clusters based on the user-interests, wherein the clustering is performed by traversing each node of each connected component, and (a) identifying the highest-degree node as a clustering centroid of a current cluster, (b) determining a neighborhood of nodes neighboring the clustering centroid, (c) selecting a candidate neighboring node, (d) evaluating the candidate neighboring node, based on the one or more user-interests, for cluster membership, whereby qualifying candidate neighboring nodes are merged into the current cluster and the edges between disqualifying candidate neighboring nodes and the current cluster are removed, and repeating (a) through (d) until the neighborhood is empty, thereby assigning the neighborhood nodes to one or more clusters, and output the plurality of clusters.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and associated memory storing instructions that when executed by the processing circuitry, cause the processing circuitry to:
for each of a plurality of input images,
input to a multi-modal large language model (MLLM) a corresponding input image together with embedding-generation instruction text describing one or more user-interests, and
via the MLLM, generate a response to the embedding-generation instruction text;
construct a weighted relational graph including a plurality of nodes connected by edges, in which each node corresponds to one of the plurality of input images and each edge has a weight determined by pairwise similarity between a user-interest-biased embedding corresponding assigned by a trained adapter layer to each of the respective nodes each edge connects;
perform clustering of the nodes in the weighted relational graph using an MLLM-based agent, to identify a plurality of clusters based on the user-interests; and
output the plurality of clusters.

2. The computing system of claim 1, wherein:
the MLLM includes a trained projector;
the trained adapter layer is trained on pairwise similarity between relational-graph nodes; and
the processing circuitry is further configured to project the MLLM response with the trained projector to form the user-interest-biased image embedding corresponding to the input image.

3. The computing system of claim 1, wherein to construct the weighted relational graph, edges with weights that do not exceed a predetermined pairwise similarity threshold are filtered out of the weighted relational graph, thereby forming a plurality of separate connected components of the weighted relational graph.

4. The computing system of claim 2, wherein the performing of the clustering is accomplished by the MLLM-based agent traversing each node of each connected component and
(a) identifying the highest-degree node as a clustering centroid of a current cluster,
(b) determining a neighborhood of nodes neighboring the clustering centroid,
(c) selecting a candidate neighboring node,
(d) evaluating the candidate neighboring node, based on the one or more user-interests, for cluster membership, whereby qualifying candidate neighboring nodes are merged into the current cluster and the edges between disqualifying candidate neighboring nodes and the current cluster are removed, and
(e) repeating (a) through (d) until the neighborhood is empty, thereby assigning the neighborhood nodes to one or more clusters.

5. The computing system of claim 4, wherein the MLLM agent is one of a plurality of MLLM-based agents each of which traverses a respective connected component in parallel to carry out (a) through (e) until all neighboring nodes are clustered in a respective connected component.

6. The computing system of claim 1, wherein the MLLM-based agent performs inter-cluster similarity assessments to merge semantically redundant clusters.

7. The computing system of claim 1, wherein the MLLM-generated response to the embedding-generation instruction text is a semantically detailed description of the input image containing a specialized token, the semantically detailed description being a reasoning statement generated by the MLLM, the specialized token enabling the MLLM to transform the reasoning statement into the user-interest-biased image embedding.

8. The computing system of claim 7, wherein:
semantic similarity of pairwise reasoning statements is evaluated via the MLLM-based agent to infer binary pseudo labels for the user-interest-biased image embeddings; and
the MLLM-based agent decides whether a candidate neighboring node qualifies for cluster membership according to the binary pseudo label associated with the candidate neighboring node.

9. The computing system of claim 1, wherein the trained adapter layer is a low-rank adapter (LoRA) layer.

10. The computing system of claim 1, wherein the processing circuitry is further configured to perform a content recommendation operation by selecting content or a user associated with one of the output clusters, to thereby cause the selected content to be displayed or the selected user to receive a display of content.

11. The computing system of claim 1, wherein the content is grouped according to cluster type, to provide diversity, coverage, and serendipity to the content recommendation.

12. A method of user-interest-tailored clustering from a visual dataset, the method comprising:
for each of a plurality of input images from the visual dataset,
inputting to a multi-modal large language model (MLLM) a corresponding input image together with embedding-generation instruction text describing one or more user-interests, and
via the MLLM, generating a response to the embedding-generation instruction text, and
constructing a weighted relational graph including a plurality of nodes connected by edges, in which each node corresponds to one of the plurality of input images and each edge has a weight determined by pairwise similarity between a user-interest-biased embedding assigned by a trained adapter layer corresponding to the each of the respective nodes each edge connects;
performing clustering of the nodes in the weighted relational graph using an MLLM-based agent, to identify a plurality of clusters based on the user-interests; and
outputting the plurality of clusters.

13. The clustering method of claim 12, wherein:
the MLLM includes a trained projector;
the trained adapter layer is trained on pairwise similarity between relational-graph nodes; and
the clustering method further comprises projecting the MLLM response with the trained projector to form a user-interest-biased image embedding corresponding to the input image.

14. The clustering method of claim 12, wherein constructing the weighted relational graph includes filtering out of the weighted relational graph edges with weights that do not exceed a predetermined pairwise similarity threshold, thereby forming a plurality of separate connected components of the weighted relational graph.

15. The clustering method of claim 13, wherein the performing of the clustering is accomplished by the MLLM-based agent traversing each node of each connected component and
(a) identifying the highest-degree node as a clustering centroid of a current cluster,
(b) determining a neighborhood of nodes neighboring the clustering centroid,
(c) selecting a candidate neighboring node,
(d) evaluating the candidate neighboring node, based on the one or more user-interest, for cluster membership, whereby qualifying candidate neighboring nodes are merged into the current cluster and the edges between disqualifying candidate neighboring nodes and the current cluster are removed, and
(e) repeating (a) through (d) until the neighborhood is empty, thereby assigning the neighborhood nodes to one or more clusters.

16. The clustering method of claim 15, wherein the MLLM agent is one of a plurality of MLLM-based agents each of which traverses a respective connected component in parallel to carry out (a) through (e) until all neighboring nodes are clustered in a respective connected component.

17. The clustering method of claim 12, wherein the MLLM-generated response to the embedding-generation instruction text is a semantically detailed description of the input image containing a specialized token, the semantically detailed description being a reasoning statement generated by the MLLM, the specialized token enabling the MLLM to transform the reasoning statement into the user-interest-biased image embedding.

18. The clustering method of claim 17, further comprising:
evaluating, via the MLLM-based agent, semantic similarity of pairwise reasoning statements to infer binary pseudo labels for the user-interest-biased image embeddings; and
deciding via the MLLM-based agent whether a candidate neighboring node qualifies for cluster membership according to the binary pseudo label associated with the candidate neighboring node.

19. The clustering method of claim 12, further comprising performing a content recommendation operation by selecting content or a user associated with one of the output clusters, to thereby cause the selected content to be displayed or the selected user to receive a display of content.

20. A computing system, comprising:
processing circuitry and associated memory storing instructions that when executed by the processing circuitry, cause the processing circuitry to:
for each of a plurality of input images,
input to a multi-modal large language model (MLLM) a corresponding input image together with embedding-generation instruction text describing one or more user-interests, wherein the MLLM includes a trained projector and a trained adapter layer trained on pairwise similarity between relational-graph nodes,
via the MLLM generate a response to the embedding-generation instruction text, and
project the MLLM response with the trained projector to form a user-interest-biased image embedding corresponding to the input image;
construct a weighted relational graph including a plurality of nodes connected by edges, in which each node corresponds to one of the plurality of input images and each edge is each a weight determined by pairwise similarity between the user-interest-biased embeddings assigned by the trained adapter layer corresponding to the respective nodes each edge connects, and filter out of the weighted relational graph edges with weights that do not exceed a predetermined pairwise similarity threshold, leaving a plurality of separate connected components of the weighted relational graph;
perform clustering of the nodes in the weighted relational graph using an MLLM-based agent, to identify a plurality of clusters based on the user-interests, wherein the clustering is performed by traversing each node of each connected component and
(a) identifying the highest-degree node as a clustering centroid of a current cluster,
(b) determining a neighborhood of nodes neighboring the clustering centroid,
(c) selecting a candidate neighboring node,
(d) evaluating the candidate neighboring node, based on the one or more user-interests, for cluster membership, whereby qualifying candidate neighboring nodes are merged into the current cluster and the edges between disqualifying candidate neighboring nodes and the current cluster are removed, and
repeating (a) through (d) until the neighborhood is empty, thereby assigning the neighborhood nodes to one or more clusters; and
output the plurality of clusters.
